(19) United States
(12) Patent Application Publication
(10) Pub. No.: US 2005/0055552 A1
(43) Pub. Date: Mar. 10, 2005

(54) Assurance system and assurance method

(75) Inventor: Nobuyuki Shigeeda, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/936,566

(22) Filed: Sep. 9, 2004

(30) Foreign Application Priority Data
Sep. 10, 2003 (JP) 2003-318320

(51) Int. Cl. H04L 9/00

(52) U.S. Cl. 713/171

(57) ABSTRACT

In a client PC or device, the reliability of multiplexed authentication servers is assured. In an assurance system including a client PC (1-1, 1-3), an authentication server 1 (1-7), and a device (1-5) connected to a network, a multiplexed system is built by arranging an authentication server 2 (1-8) in order to back up the authentication server 1 (1-7), public key cryptography is used for encrypted communication between the client PC, the authentication servers 1 and 2, and the device, and the public keys of the authentication servers 1 and 2 are electronically signed by using the private key of one system administrator (1-10) by public key cryptography.

### FIELD OF THE INVENTION

The present invention relates to an assurance system including a plurality of client server PCs, devices, and an authentication server which authenticates users who will use the client server PCs and devices and controls access to resources and, more particularly, a duplexed system (redundant system) which backs up the function of an authentication server when failures occur in it and, more particularly, a system which imparts reliability to a plurality of authentication servers including the redundant system and confirms the reliability.

### BACKGROUND OF THE INVENTION

If a user wants to use a resource of some kind on a logic domain including client PCs, servers, and devices connected to a network, authentication of the user and grant of a resource access right are necessary. An authentication server in the client server system makes use of its function to authenticate the user and grant an access right on the basis of a unique or standardized protocol.

Additionally, in a one-to-one communication between, e.g., a client PC and a server or a device and a server, security between them must sometimes be ensured. For example, the confidentiality and integrity of communication data need to be assured, or imposing of a communication partner must be prevented. According to a conventional key distribution method using public key cryptography, imposing of a communication partner can be prevented, and an encryption key to encrypt communication data can securely be distributed.

In this case, the authentication server also has a function of providing a key distribution service using public key cryptography to client PCs or devices. A secure and confidential network security in the domain is implemented by the authentication server.

The authentication server which provides the above-described security function must be the only system in the domain. That is, functions such as user management and encryption key management/distribution must consistently be executed by one authentication server. This is necessary for avoiding any problem of security (security hole) such as imposing of the authentication server.

However, if a failure occurs in only authentication server in the domain, the functions such as user authentication and grant of an access right cannot operate at all. In this state, the user can obtain neither authentication nor a use right from the authentication server and therefore cannot use a desired resource such as a device or file server even when it normally runs. This is because there is only one authentication server belonging to the domain.

As described above, the authentication server must be the only apparatus which runs in the domain because of its nature of function. Simultaneously, the problem of system failure as described above has been pointed out for some time. To solve this problem, for a client server system which forms a domain, multiplexed or redundant authentication servers have been proposed and put into practical use.

More specifically, a plurality of authentication servers which control authentication in a domain are prepared, and all of them are operated. However, if the plurality of authentication servers are simultaneously running, a problem arises as described above. To prevent this, priority for effective run is set for each authentication server in advance so that the authentication servers can function in descending order of priority.

More specifically, the plurality of authentication servers which are running communicate with each other to confirm whether they are normally running. This process is periodically executed. If the primary authentication server stops running because of a failure, the secondary authentication server is automatically raised to the authentication server of the domain to continuously provide the authentication service.

In the authentication servers having the multiplexing function, when the first-priority authentication server stops the authentication function due to a failure, the second-priority authentication server automatically takes over the work such as authentication or granting an access right. When the third-priority authentication server is present, and a failure occurs in the second-priority authentication server too, the third-priority authentication server automatically functions.

As described above, the problem that the resources of the domain cannot be used when a failure occurs in an authentication server can be solved by multiplexing authentication servers. On the other hand, a new problem arises from the viewpoint of reliability of the security function for which the authentication server has responsibility. That is, imposing of the authentication server itself may occur.

In the system with multiplexed authentication servers, normally, the administrator sets up and activates the backup authentication servers. In this case, the mechanism which assures the reliability of the authentication servers to be activated for backup is imperfect. If a backup authentication server is a server (rogue server) other than the authentic server desired by the administrator, and a failure occurs in the first-priority authentication server, the imposing authentication server may be validated.

Once the rogue server runs, an undesirable user other than users who have been registered according to regular procedures may be authenticated and allowed to access resources. Alternatively, a password may be stolen from authentication procedures for a regular user. That is, various kinds of problems in security arise.

Such a rogue server which causes many problems in security must be inhibited from taking part in the domain as a backup authentication server. For this purpose, a method is currently used in which authentication of the administrator's password is requested in setting up a backup authentication server. More specifically, after properly installing and activating authentication servers, a work step is prepared in which the first-priority authentication server causes the second-priority authentication server to participate in the domain. To make an authentication server participate, authentication of the administrator's password is necessary so that input of the administrator's password is requested.

Only when the input password is authentic, the first-priority authentication server permits the second-priority authentication server to take part in the domain as a backup server. An administrator's password is normally information only the administrator can know and is never known by general users in principle. Hence, when such a work step is introduced, the first-priority authentication server can prevent the second-priority authentication server from participating in the domain without permission. Accordingly, the first-priority authentication server can rely on the second-priority authentication server.

As described in the prior art, the method of authenticating the administrator's password is effective for making the first-priority authentication server rely on the second-priority authentication server. However, it is difficult for a client PC or device on the domain to determine whether the second-priority authentication server, i.e., backup authentication server is reliable.

Generally, the work for registering the address of a backup authentication server in a client PC or device is executed by the owner or user of the client PC or device. The work step of causing the domain administrator to input his/her password to confirm the reliability is normally not prepared on the client PC or device side. For this reason, a client PC user or device user who wants to set the address of the second-priority authentication server has no means for confirming its reliability. In addition, he/she can set the address without confirmation.

This can be regarded as a security hole in the authentication server multiplexed system because it permits imposing of the multiplexed authentication servers in the domain. Additionally, the conventional administrator password authentication method cannot completely prevent imposing of authentication servers. This is because when an imposing authentication server runs on the domain, the address of the imposing authentication server can be provided to a user of the domain so that he/she can set the address in his/her client PC or device. That is, the system user is caused to set the false address.

Once the user sets the address of the imposing authentication server in the client PC or device, various kinds of problems in security, as described above, arise when the first-priority authentication server goes down due to a failure.

### SUMMARY OF THE INVENTION

The present invention has been proposed to solve the conventional problems, and has as its objects to provide an assurance system and assurance method which assure, in a client PC or device, the reliability of a multiplexed authentication server.

It is another object of the present invention to provide a mechanism to set the address of a multiplexed authentication server in a client PC or device after authenticating the reliability of the multiplexed authentication server,-thereby preventing registration of an imposing authentication server and ensuring perfect security of the domain.

In order to achieve the above objects, an assurance system according to the present invention is characterized by including a client PC, an authentication server, and a device connected to a network and assures reliability in a multiplexed system of an authentication server which collectively manages identification and authentication of a user and access and permission to a resource, wherein the multiplexed system of the authentication server is built in order to back up the authentication server, public key cryptography is used for encrypted communication between the client PC, the authentication server, and the device, and before distribution of a public key of the authentication server, public keys of all authentication servers are electronically signed by using a private key of one system administrator by public key cryptography.

In order to achieve the above objects, an assurance system according to the present invention is characterized by including a client PC, an authentication server, and a device connected to a network and assures reliability in a multiplexed system of an authentication server which collectively manages identification and authentication of a user and access and permission to a resource, wherein before electronically signed public keys of all authentication servers and pieces of address information of the authentication servers are registered, the client PC and the device verify authenticity of the public keys of the authentication servers by using a public key of a system administrator.

In order to achieve the above objects, the system according to the present invention is wherein the client PC and the device hold the public key and address information of a first authentication server only when the authenticity of the electronic signature is confirmed.

In order to achieve the above objects, the system according to the present invention is wherein in holding a public key and address information of an authentication server set up for backup, the client PC and the device verify authenticity of the public key of the backup authentication server by using the public key of the system administrator, which is used to confirm the authenticity of the electronic signature for the first time, and only when the authenticity is confirmed, the client PC and the device hold the public key and address information of the backup authentication server.

In order to achieve the above objects, an assurance method according to the present invention is characterized by assuring reliability in a multiplexed system of an authentication server which collectively manages identification and authentication of a user and access and permission to a resource, the multiplexed system including a client PC, an authentication server, and a device connected to a network, comprising steps of: generating a key pair of a primary authentication server by public key cryptography in setting up the first authentication server; generating a key pair of a system administrator; electronically signing a public key of the primary authentication server itself by using a private key of the system administrator; generating a key pair of a backup authentication server by public key cryptography in setting up the backup authentication server; electronically signing a public key of the backup authentication server itself by using the private key of the system administrator; and causing the client PC and the device to receive public keys of the primary authentication server and the backup authentication server, which are associated with electronic signatures, verify authenticity of the electronic signatures by using a public key of the same system administrator, and after verification, store the public keys of the authentication servers in predetermined storage areas of the client PC and the device.

In order to achieve the above objects, an assurance method according to the present invention is characterized by assuring reliability in a multiplexed system of an authentication server which collectively manages identification and authentication of a user and access and permission to a resource, the multiplexed system including a client PC, an authentication server, and a device connected to a network, wherein in storing address information of the authentication server in predetermined storage areas, the client PC and the device verify authenticity of electronic signature by using a public key of a system administrator, and only when the authenticity is confirmed, the client PC and the device store the address information of the authentication server.

According to the system of the present invention, which assures reliability in the authentication server multiplexed system, in setting up a backup authentication server and causing it to participate in a domain, user information encrypted by the private key of the system administrator is sent to the backup authentication server. Hence, the security of the user information can be ensured. In addition, in making the backup authentication server participate in the domain, the reliability can be imparted to the system administrator.

The address of an authentication server is registered in the client PC or device after the authenticity of the public keys of all authentication servers is confirmed by the public key of one system administrator. Hence, reliability is imparted to all the authentication servers by one system administrator. Even if a malicious third party attempts to register an illicit authentication server in the client PC or device for a purpose of illicitly acquiring classified information, it can be prevented.

The public key of the system administrator is made open to the public. Hence, anybody can acquire the public key of the system administrator and verify signature data on the client PC or device side. That is, the system administrator himself/herself need not witness setup of the client PC or device and input a secret password. For this reason, the TCO of system administrator can be reduced.

On the other hand, in the client PC or device, a safety mechanism functions to register only the address information of an authentication server whose authenticity is confirmed. Hence, any careless mistake in procedures can be prevented, and for example, any erroneous registration of the address of an undesirable authentication server can be prevented.

Other feature and advantages of the present invention will be apparent from the following description taken in conjunction with the accompanying drawings, in which like references characters designate the same or similar parts throughout the figures thereof.

### BRIEF DESCRIPTION OF THE DRAWINGS

The accompanying drawings, which are incorporates in and constitute a part of the specification, illustrate embodiments of the invention and, together with the description, serve to explain the principle of the invention.

FIG. 1 is a view showing the overall arrangement of a system which assures reliability in an authentication server multiplexed system according to the present invention;

FIG. 2 is a flowchart showing a process for imparting reliability to a primary authentication server when it is set up in the assurance system according to the present invention;

FIG. 3 is a flowchart showing a process for imparting reliability to a secondary authentication server when it is set up in the assurance system according to the present invention;

FIG. 4 is a flowchart for explaining authentication server address registration processing in a client PC or device;

FIG. 5 is a flowchart for explaining authentication server address registration processing in a client PC or device; and

FIG. 6 is a view showing the overall arrangement of an assurance system according to another embodiment of the present invention, which assures the reliability of an authentication server multiplexed system.

### DETAILED DESCRIPTION OF THE PREFERRED EMBODIMENTS

The embodiments of the assurance system according to the present invention will be described below with reference to the accompanying drawings.

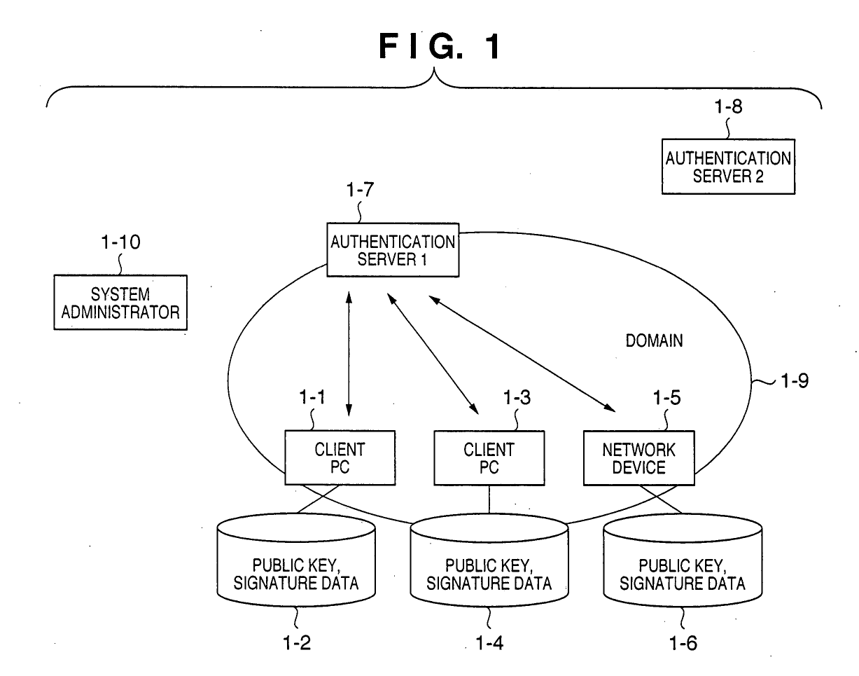

FIG. 1 is a view showing the overall arrangement of a system which assures reliability in an authentication server multiplexed system according to the present invention.

As shown in FIG. 1, the assurance system according to this embodiment includes client PCs 1-1 and 1-3 which provide services for users, a network device 1-5, and an authentication server 1 1-7 which collectively executes identification and authentication of users and access control. These components are connected by a physical network connection means so that information communication between them is possible.

In the assurance system according to this embodiment, the network device 1-5 is a printing device connected to the network or a multifunctional device having scanner, printer, and FAX functions. A file server (not shown) or the like may also be included in the system. As the physical network connection means, a wired communication means by Ethernet (R) or wireless information communication based on the wireless LAN standard can be used. Either means is slated as the network means in this system.

The authentication server 1 1-7 collectively executes identification and authentication of system users and access control and forms a logic domain 1-9 of security which controls the system security. The domain 1-9 also means a logical boundary for discrimination from another security domain collectively controlled by another authentication server 2 1-8. Hence, the plurality of client PCs, devices, and authentication servers physically connected by the same network means may be divided logically and operated in a plurality of security domains.

In principle, one authentication server is present in one domain as a preferred authentication server (primary authentication server) and controls the security of the domain. When a plurality of domains are present, each domain has a primary authentication server. Each of authentication servers may have a function for ensuring a relationship built on trust between them to implement authentication or access control across the domains.

The security function in a domain is collectively controlled by one primary authentication server. If a failure occurs in this authentication server, the users cannot use the resources of the domain at all. To solve this problem, authentication servers are multiplexed. In this case, even when a failure occurs in one authentication server, another authentication server for backup takes over processing from then. This mechanism is called a multiplexed system, redundant system, or backup system. The authentication server for backup is called a backup authentication server or secondary authentication server.

In the assurance system which assures reliability in the authentication server multiplexed system according to the present invention, each authentication server has a function corresponding to the multiplexed system. The authentication server 1 1-7 serves as the primary authentication server. When a failure occurs, the authentication server 1 1-7 is automatically switched to the authentication server 2 1-8 serving as a backup authentication server so that it can continue processing such as authentication.

-Setup of Primary Authentication Server and Building of Domain-

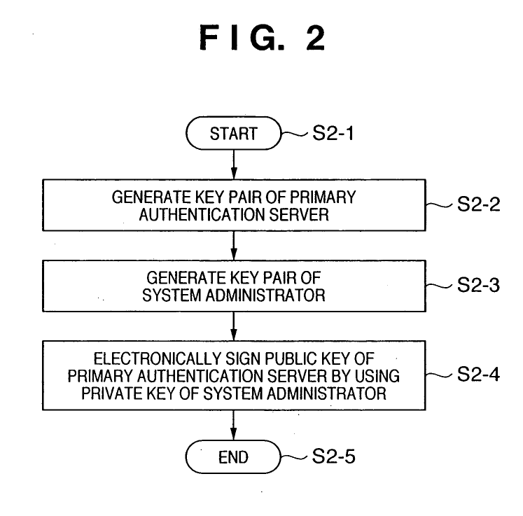

FIG. 2 is a flowchart showing a process for imparting reliability to the primary authentication server when it is set up in the assurance system according to the present invention.

Before the start of the process shown in FIG. 2, an OS and application software necessary for the function of the authentication server are properly installed. Setting and registration of information necessary for connection to the network are also done in advance. Then, in step S2-1 in FIG. 2, the primary authentication server setup process starts.

In step S2-2, a key pair of the primary authentication server itself is generated. In the assurance system according to the present invention, the authentication server 1 1-7 needs to generate a set (pair) of a public key and a private key based on public key cryptography. These encryption keys are used to prevent imposing or protect the security of communication between the authentication server 1 1-7 and the client PC 1-1 or 1-3 or the network device 1-5. As the public key cryptography, a known standard cryptographic algorithm is used. For example, RSA or Diffie & Hellman can be used.

In step S2-3, a key pair of a system administrator 1-10 is generated. The system administrator 1-10 is the administrator of the entire domain 1-9 including the authentication server 1 1-7 and has responsibility for the system security. Details of key pair generation are the same as in key pair generation of the authentication server 1 1-7.

In step S2-4, the public key of the primary authentication server 1 1-7 is electronically signed by the private key of the system administrator 1-10. Electronic signature is used as a means for causing the system administrator 1-10 to guarantee that the public key of the primary authentication server 1 1-7 has not been altered and prove this fact to a third party. The public keys of the primary authentication server 1 1-7 and system administrator 1-10 are made open to the client PCs 1-1 and 1-3 and the network device 1-5.

As an example of the above-described electronic signature method, the hash value of public key data is calculated and encrypted by using the private key of the system administrator 1-10. For the hash calculation, a known hash algorithm which is set in advance in setting up the system is used.

The authenticity of signature data is confirmed in the following way.

Electronic signature data and public key are acquired together in advance. The signature data is decrypted by using the public key of the system administrator 1-10, which is acquired in advance. Next, the hash algorithm that is set in advance in setting up the system is applied to the public key data which is acquired together with the signature data to calculate a predetermined hash value. If the value obtained by decrypting the signature data coincides with the hash of the public key, it can be determined that the public key data acquired together is not altered, and it is the public key signed by the system administrator 1-10.

The flow advances to step S2-5. Reliability is imparted to the primary authentication server 1 1-7 by the system administrator 1-10, and the setup is completed. When this step is ended, the domain 1-9 can be regarded as built.

-Setup of Backup Authentication Server and Participation in Domain-

A process for setting up the secondary authentication server 2 1-8 in the thus built domain 1-9 and causing the system administrator 1-10 to impart reliability will be described next.

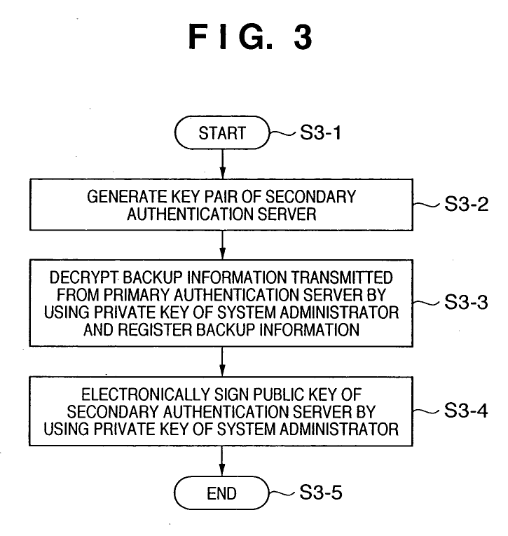

FIG. 3 is a flowchart showing a process for imparting reliability to the secondary authentication server when it is set up in the assurance system according to the present invention.

Before causing the system administrator 1-10 to impart reliability, an OS and application software necessary for the function of the authentication server are properly introduced, and setting and registration of information necessary for connection to the network are done in advance, as in the primary authentication server 1 1-7. Then, in step S3-1 in FIG. 3, the secondary authentication server setup process starts.

In step S3-2, a key pair of the secondary authentication server 2 1-8 is generated. Details of key pair generation are the same as in those described in step S2-2 for key pair generation of the authentication server 1 1-7. These encryption keys are used to prevent imposing or protect the security of communication between the authentication server 2 1-8 and the client PC 1-1 or 1-3 or the network device 1-5. Of the key pair of the secondary authentication server 2 1-8, the public key is made open to the client PCs 1-1 and 1-3 and the network device 1-5.

In step S3-3, backup information transmitted from the primary authentication server 1 1-7 is decrypted by using the private key of the system administrator 1-10 and registered in a predetermined storage area of the secondary authentication server 2 1-8. The backup information mainly contains various kinds of user information necessary for identification and authentication of a user and access control. This information is important for maintaining the security of the domain 1-9. As the secondary authentication information, up-to-date backup information must be held as much as possible. If a failure occurs in the primary authentication server 1 1-7, the secondary authentication server must execute, e.g., the user authentication function immediately.

The backup information having the above-described nature is transmitted from the primary authentication server 1 1-7 to the secondary authentication server 2 1-8 when it is set up. Since transmission is normally done through the network, the security of information must sufficiently be protected. For this purpose, the backup information is encrypted by the private key of the system administrator 1-10 and then transmitted to the secondary authentication server 2 1-8.

In step S3-4, the secondary authentication server 2 1-8 receives the encrypted backup information, decrypts it by the private key of the system administrator 1-10, and holds the backup information in a predetermined storage area. Normally, the private key of the system administrator 1-10 is information only the administrator can know. Hence, in the assurance system according to the present invention, the system administrator 1-10 is always involved in the setup to register the secondary authentication server 2 1-8.

The flow advances to step S3-5. Reliability is imparted to the authentication server 2 1-8 by the system administrator 1-10, and the setup is completed. Accordingly, the secondary authentication server 2 1-8 participates in the domain 1-9.

-Registration of Authentication Server Address in Client PC or Network Device-

The client PC 1-1 or 1-3 or the network device 1-5 must communicate with the authentication server which manages the security of the domain 1-9 to authenticate users. To do this, after the client PC 1-1 or 1-3 or the network device 1-5 is properly set up, the address information of the authentication server on the network must be registered in advance.

Address information on the network can take several forms depending on the communication protocol in the network. For example, IP address information by TCP/IP corresponds to address information in this case. For NetBEUI as the protocol of Windows (R), a computer name corresponds to the address information.

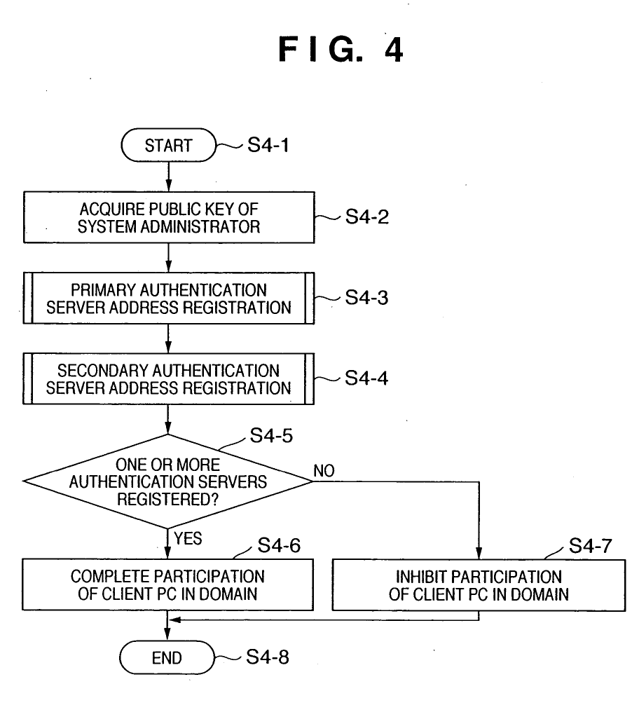

FIG. 4 is a flowchart for explaining authentication server address registration processing in the client PC 1-1 or 1-3 or the network device 1-5.

After the client PC 1-1 or 1-3 or the network device 1-5 is properly set up by a user or expert staff, the authentication server address registration process starts in step S4-1 in FIG. 4.

In step S4-2, the public key of the system administrator 1-10 is acquired. The public key can be acquired offline using, e.g., a predetermined magnetic medium or using a predetermined existing directory server or a public key distribution service. The public key of the system administrator 1-10 acquired at this time is used to confirm the authenticity of an electronic signature (to be described later).

In step S4-3, the address of the primary authentication server 1 1-7 is registered in the client PC 1-1 or 1-3 or the network device 1-5. Address information registration will be described later in detail with reference to a flowchart.

In step S4-4, the address of the secondary authentication server 2 1-8 is registered in the client PC 1-1 or 1-3 or the network device 1-5. This will also be described later.

With the processing up to step S4-4, the address information of the primary authentication server 1 1-7 and that of the secondary authentication server 2 1-8 are registered in the client PC 1-1 or 1-3 or the network device 1-5. Accordingly, for example, even when a failure occurs in the primary authentication server 1 1-7, the secondary authentication server 2 1-8 can take over the function and continuously execute the processing. Even when a failure occurs in the primary authentication server 1 1-7, the user can continuously use the resources in the domain 1-9.

In this embodiment, only two pieces of address information of the-primary authentication server 1 1-7 and secondary authentication server 2 1-8 are set in the client PC 1-1 or 1-3 or the network device 1-5. Actually, this arrangement may be expanded. When the third or fourth authentication server can be registered, an advanced multiplexed system can be built, and the risk can further be reduced.

In step S4-5, it is evaluated whether one or more authentication servers are registered. This step is prepared to discriminate a case in which no authentication server addresses are registered at all in the client PC 1-1 or 1-3 or the network device 1-5. The client PC 1-1 or 1-3 or the network device 1-5 in which no authentication server addresses are registered at all cannot access any authentication server.

It means that authentication in the domain 1-9 is impossible, and the client PC 1-1 or 1-3 or the network device 1-5 cannot participate in the domain 1-9. When this processing step is prepared, the client PC 1-1 or 1-3 or the network device 1-5, which is not recognized by the system administrator 1-10, can be prevented from participating in the domain 1-9 without permission.

If YES in step S4-5, the flow advances to step S4-6. On the other hand, if NO in step S4-5, the flow advances to step S4-7.

Processing in step S4-6 is executed when one or more authentication servers are registered. More specifically, participation of the client PC 1-1 or 1-3 or the network device 1-5 in the domain 1-9 is completed. Step S4-6 is the last step in normal processing.

Processing in step S4-7 is executed when no authentication servers are registered at all due to some reason. More specifically, participation of the client PC 1-1 or 1-3 or the network device 1-5 in the domain 1-9 is not permitted at all, and the processing is ended after issuing a dialog or log that notifies the user of it.

Then, the flow advances to step S4-8 so that the step of making the client PC 1-1 or 1-3 or the network device 1-5 participate in the domain 1-9 is ended.

An authentication server address registration process in the client PC 1-1 or 1-3 or the network device 1-5 will be described next.

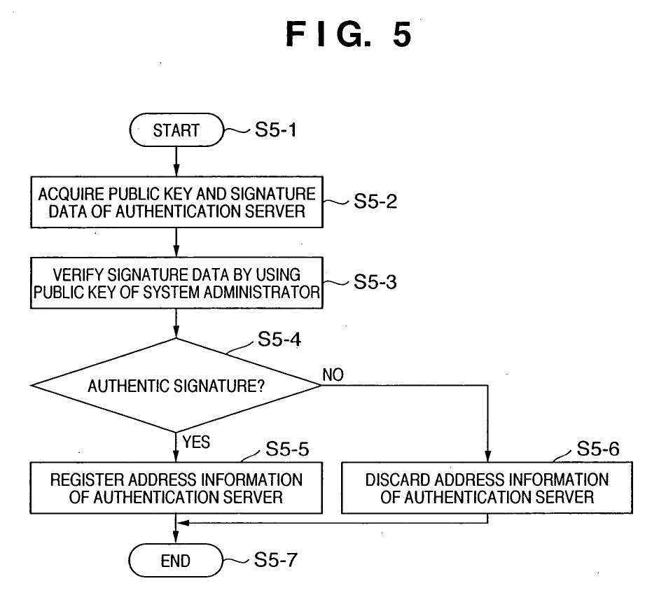

FIG. 5 is a flowchart of authentication server address registration processing in the client PC 1-1 or 1-3 or the network device 1-5.

In step S5-1, the authentication server address registration process starts when the authentication server address registration processing is executed in step S4-3 or S4-4.

In step S5-2, the client PC 1-1 or 1-3 or the network device 1-5 acquires the public key and signature data of an authentication server. The signature data is generated when the authentication server is set up and imparted reliability by the system administrator 1-10 (steps S2-4 and S3-3). The public key and signature data are acquired from the authentication server through the network in accordance with a predetermined protocol. However, they may be acquired offline using, e.g., a predetermined magnetic disk.

In step S5-3, the signature data acquired in step S5-2 is verified by using the public key of the system administrator 1-10. The signature data is verified in accordance with the same procedures as described in the above setup of the primary authentication server 1 1-7 and building of the domain 1-9. More specifically, the signature data is decrypted by using the public key of the system administrator 1-10. On the other hand, the hash value of the public key of the authentication server is calculated on the basis of the hash algorithm set in advance in introducing the system.

In step S5-4, it is determined whether the signature data verified in step S5-3 is authentic. More specifically, it is determined whether the data decrypted by the public key of the system administrator 1-10 coincides with the hash value. If they coincide with each other, it can be determined that the public key of the authentication server is not altered, and it is signed by the authentic system administrator 1-10.

If YES in step S5-4, the flow advances to step S5-5. If NO in step S5-4, the flow advances to step S5-6.

Processing in step S5-5 is executed when the signature data of the public key is authentic. The address information of the authentication server is held in the client PC 1-1 or 1-3 or the network device 1-5.

Processing in step S5-6 is executed when the signature data of the public key is not authentic. The public key associated with the signature data is discarded.

In step S5-3, as the public key of the system administrator 1-10 for verification of the signature data, the same key is used in both registering the address of the primary authentication server 1 1-7 (step S4-3) and registering address of the secondary authentication server 2 1-8 (step S4-4). Accordingly, the security in the domain 1-9 managed by one system administrator 1-10 can be assured in the client PC 1-1 or 1-3 or the network device 1-5.

To force the public key of the same system administrator 1-10 to be used in step S5-3, in the assurance system according to the present invention, the public key of the system administrator 1-10, which is acquired in step S4-2, is held in a predetermined storage area 1-2, 1-4, or 1-6 of the client PC 1-1 or 1-3 or the network device 1-5. When step S5-3 is executed in the processing in step S4-3 and 4-4, the public key of the system administrator 1-10 is automatically acquired from the storage area as software program. Then, the processing in step S5-3 is executed.

The flow advances to step S5-7. The authenticity of the public key of the authentication server is determined, and the address information of the authentication server is registered or discarded. The authentication server address registration process is thus ended. The flow returns to step S4-5 to execute the above-described processing.

-Switching of Authentication Server-

Processing for switching the authentication server 1 1-7 to the authentication server 2 1-8 prepared for back up when a failure occurs in the authentication server 1 1-7 will be described next.

To allow a user to access and use a resource, the client PC 1-1 or 1-3 or the network device 1-5 which participates in the domain 1-9 exchanges first identification and authentication of user and access control information. At this time, the client PC 1-1 or 1-3 or the network device 1-5 tries access from the primary authentication server 1 1-7 on the basis of the registered authentication server address information.

If communication with the primary authentication server 1 1-7 fails, and acquisition of these pieces of information fails, the client PC 1-1 or 1-3 or the network device 1-5 accesses next the address information registered as the secondary authentication server 2 1-8. As an example of fail, an error is returned as a response in communication according to a predetermined protocol. Alternatively, no response is returned at all, and communication times out.

### Other Embodiment

An assurance system according to another embodiment of the present invention, which assures reliability in an authentication server multiplexed system, will be described next.

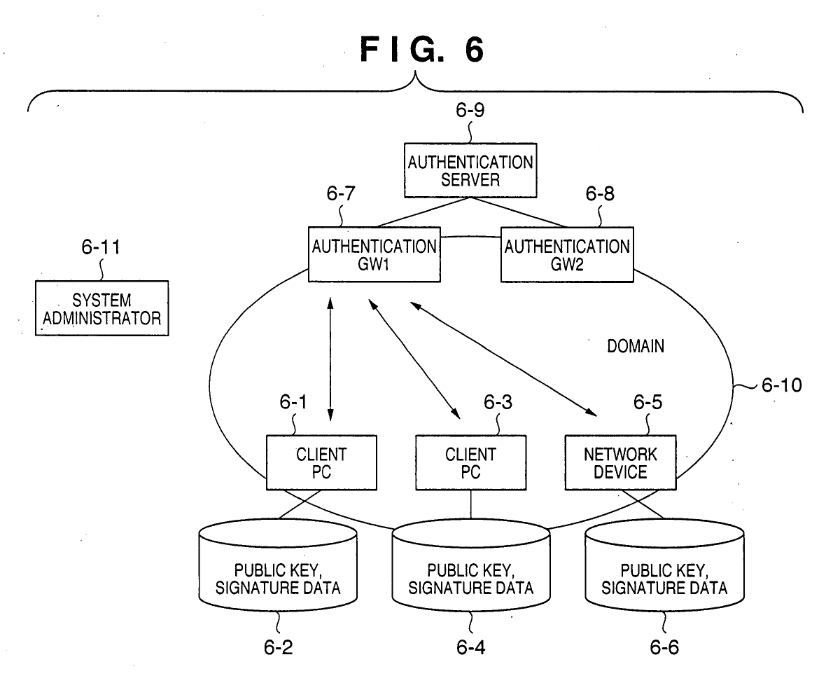

FIG. 6 is a view showing the overall arrangement of the assurance system according to another embodiment of the present invention, which assures the reliability of an authentication server multiplexed system.

Reference numerals 6-1 to 6-6 in FIG. 6 denote client PCs and device in the arrangement of the assurance system according to the present invention and equal the components 1-1 to 1-6 in FIG. 1 described in the above embodiment.

An authentication server 6-9 shown in FIG. 6 intensively executes identification and authentication of users and management and granting access control information. This corresponds to, e.g., Active Directory of Windows (R).

Reference numeral 6-7 in FIG. 6 denotes a primary authentication GW (gateway) 1. The authentication GW intervenes between the authentication server 6-9 and the client PCs 6-1 and 6-3 and network device 6-5 to be proxy in authentication processing of users. This arrangement can execute authentication processing as a proxy to set up the assurance system according to the present invention when the user is already using the general-purpose authentication server 6-9 since before he/she sets up the assurance system according to the present invention. Hence, the authentication GW itself never directly executes authentication processing for the client PC 6-1 or 6-3 or the network device 6-5.

When a plurality of kinds of authentication servers (e.g., Windows (R) and Notes) are present in the existing user environment, the authentication GW 1 6-7 executes authentication processing on behalf of these authentication servers. Accordingly, an authentication processing environment (e.g., a single sign-on function) common to the users can be provided.

Reference numeral 6-8 in FIG. 6 denotes a secondary authentication GW 2. When a failure occurs in the primary authentication GW 1 6-7, the secondary authentication GW 2 6-8 executes its function in its behalf. Reference numeral 6-10 denotes a security domain including the client PCs 6-1 and 6-3, network device 6-5, and authentication server 6-9. The domain 6-10 is collectively managed by one system administrator 6-11.

In the assurance system according to another embodiment of the present invention, the above-described authentication GW 1 6-7 and authentication GW 2 6-8 are multiplexed. Each authentication GW generates a key pair based on public key cryptography. Electronic signature by the private key of the system administrator 6-11 is executed for the public key of each authentication GW in setting up it. Accordingly, the authentication GW 1 6-7 and authentication GW 2 6-8 are set up in the domain 6-10 and imparted reliability.

To register the address information of each authentication GW in the client PC 6-1 or 6-3 or the network device 6-5, the same process as described in the above embodiment is applied. For communication between each authentication GW and the existing authentication server 6-9 in the user environment, NTLM authentication or Kerberos authentication is applied in, e.g., Windows (R). If the authentication server 6-9 is Notes, LDAP authentication may be applied. Hence, although the authentication server 6-9 itself does not execute authentication processing of users, it uses a plurality of authentication protocols. Hence, an authentication interface common to the plurality of kinds of authentication servers which are present in the user environment can be provided.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2003-318320 filed on Sep. 10, 2003, which is hereby incorporated by reference herein.

1. An assurance system which includes a client PC, an authentication server, and a device connected to a network and assures reliability in a multiplexed system of an authentication server which collectively manages identification and authentication of a user and access and permission to a resource, wherein
the multiplexed system of the authentication server is built in order to back up the authentication server, public key cryptography is used for encrypted communication between the client PC, the authentication server, and the device, and before distribution of a public key of the authentication server, public keys of all authentication servers are electronically signed by using a private key of one system administrator by public key cryptography.

2. An assurance system which includes a client PC, an authentication server, and a device connected to a network and assures reliability in a multiplexed system of an authentication server which collectively manages identification and authentication of a user and access and permission to a resource, wherein
before electronically signed public keys of all authentication servers and pieces of address information of the authentication servers are registered, the client PC and the device verify authenticity of the public keys of the authentication servers by using a public key of a system administrator.

3. The system according to claim 2, wherein the client PC and the device hold the public key and address information of a first authentication server only when the authenticity of the electronic signature is confirmed.

4. The system according to claim 2, wherein in holding a public key and address information of an authentication server set up for backup, the client PC and the device verify authenticity of the public key of the backup authentication server by using the public key of the system administrator, which is used to confirm the authenticity of the electronic signature for the first time, and only when the authenticity is confirmed, the client PC and the device hold the public key and address information of the backup authentication server.

5. An assurance method of assuring reliability in a multiplexed system of an authentication server which collectively manages identification and authentication of a user and access and permission to a resource, the multiplexed system including a client PC, an authentication server, and a device connected to a network, comprising steps of:
generating a key pair of a primary authentication server by public key cryptography in setting up the first authentication server;
generating a key pair of a system administrator;
electronically signing a public key of the primary authentication server itself by using a private key of the system administrator;
generating a key pair of a backup authentication server by public key cryptography in setting up the backup authentication server;
electronically signing a public key of the backup authentication server itself by using the private key of the system administrator; and
causing the client PC and the device to receive public keys of the primary authentication server and the backup authentication server, which are associated with electronic signatures, verify authenticity of the electronic signatures by using a public key of the same system administrator, and after verification, store the public keys of the authentication servers in predetermined storage areas of the client PC and the device.

6. An assurance method of assuring reliability in a multiplexed system of an authentication server which collectively manages identification and authentication of a user and access and permission to a resource, the multiplexed system including a client PC, an authentication server, and a device connected to a network, wherein
in storing address information of the authentication server in predetermined storage areas, the client PC and the device verify authenticity of electronic signature by using a public key of a system administrator, and only when the authenticity is confirmed, the client PC and the device store the address information of the authentication server.
